(19) United States
(12) Patent Application Publication
(10) Pub. No.: US 2012/0137242 A1
(43) Pub. Date: May 31, 2012

(54) COMPUTER SYSTEM AND CONTROL METHOD THEREOF

(75) Inventor: JIE LIU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/271,240

(22) Filed: Oct. 12, 2011

(30) Foreign Application Priority Data
Nov. 30, 2010 (CN) 201010565882.8

(51) Int. Cl. G06F 9/00; G06F 3/048

(52) U.S. Cl. 715/772; 713/100

(57) ABSTRACT

A computer system includes a number of input devices, a storage unit storing a plurality of modules, and a processing unit to execute the plurality of modules. The plurality of modules includes instructions executable by the processing unit to switch the operation mode of the computer system from a normal mode to a children mode when a mode switching command has been received. In the normal mode, the processing unit executes the number of the modules to determine which of applications of the computer system is subject to disablement and which of all the input devices is subject to disablement in the children mode, and regard any operation command on any application subject to disablement as an invalid operation command and any user operation on any input device subject to disablement as an invalid user operation when in the children mode. A related method is also provided.

### BACKGROUND

1. Technical Field

The present disclosure relates to computer systems, and particularly, to a computer system having two operation modes and a control method thereof.

2. Description of Related Art

When a computer system during a middle of a task is accidentally operated by young children, data may be lost and corrupted. For example, when a user is writing an e-mail, and a child meddles with the keyboard and/or mouse of the computer system, the e-mail may be lost. Therefore, it is desired to provide a computer system to solve the above mentioned problems.

### BRIEF DESCRIPTION OF THE DRAWINGS

The components of the drawings are not necessarily drawn to scale, the emphasis instead being placed upon clearly illustrating the principles of a computer system and a control method thereof. Moreover, in the drawings, like reference numerals designate corresponding parts throughout several views.

FIG. 1 is a hardware infrastructure block diagram of a computer system, in accordance with an embodiment.

FIG. 2 is a block diagram of main function modules stored in a storage unit of the computer system of FIG. 1, in accordance with an embodiment.

FIG. 3 is a block diagram of sub-modules of an operation processing module of FIG. 2, in accordance with an embodiment.

FIG. 4 is a block diagram of sub-modules of an operation processing module of FIG. 2, in accordance with another embodiment.

FIG. 5 is a schematic view of a user interface for users to select applications subject to disablement and input devices subject to disablement, in accordance with an embodiment.

FIG. 6 is a schematic view of an input interface for users to input applications subject to enablement and input devices subject to enablement, in accordance with an embodiment.

FIG. 7 is a flowchart of a method for controlling the operation of the computer system of FIG. 1, in accordance with an embodiment.

FIG. 8 is a flowchart of a method for determining which of applications of the computer system of FIG. 1 is subject to disablement and which of input devices of the computer system of FIG. 1 is subject to disablement, in accordance with an embodiment.

FIG. 9 is a flowchart of a method for determining which of applications of the computer system of FIG. 1 is subject to disablement and which of input devices of the computer system of FIG. 1 is subject to disablement, in accordance with another embodiment.

### DETAILED DESCRIPTION

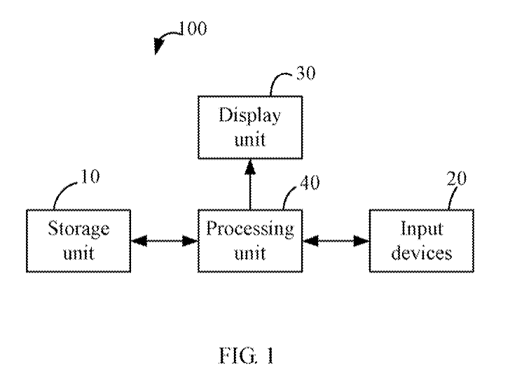

Referring to FIG. 1, an embodiment of a computer system 100 is illustrated. The computer system 100 includes a storage unit 10, a number of input devices 20, a display unit 30, and a processing unit 40. The input devices 20 may include a keyboard, a mouse, a touch pad, and the like. The display unit 30 is for displaying information. The computer system 100 includes a normal mode and a children mode. The normal mode is the default mode of the computer system 100. That is, when the computer system 100 is powered on, the computer system 100 enters the normal mode. In the normal mode, any application of the computer system 100 and any input device 20 of the computer system 100 can be operated. In the children mode, some of the applications and some of the input devices 20 cannot be operated, to avoid data loss and corruption due to errors by a child. An example is given to illustrate the present disclosure. When a user is processing an image using a graphics application, if a child wants to play games using the computer system 100, the user may switch the computer system 100 from the normal mode to the children mode and select the graphics application as an application subject to disablement. When the graphics application is selected as subject to disablement, the child cannot operate the graphics application in the children mode.

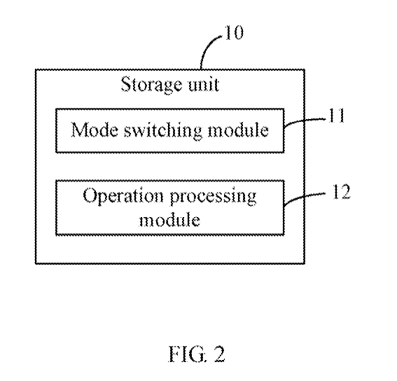

Referring to FIG. 2, the storage unit 10 stores a mode switching module 11 and an operation processing module 12. The processing unit 40 executes or runs various software components in the storage unit 20 to perform various functions of the computer system 100.

The mode switching module 11 includes various software components or set of instructions, which may be implemented by the processing unit 40 to switch the operation mode of the computer system 100 from the normal mode to the children mode when a mode switching signal has been received from any of the input devices 20 under the normal mode, and switch the operation mode of the computer system 100 from the children mode to the normal mode when the mode switching signal has been received from certain of the input devices 20 under the children mode. For example, a combination of buttons on the keyboard may be used to generate the mode switching signal for either mode.

The operation processing module 12 includes various software components or set of instructions, which may be implemented by the processing unit 40 to determine which of all the applications of the computer system 100 is subject to disablement and which of all the input devices 20 is subject to disablement once the computer system 100 is switched to the children mode, and regard any operation command on any of the applications subject to disablement as an invalid operation command and any user operation on any of the input devices 20 subject to disablement as an invalid user operation in the children mode. That is, the applications subject to disablement and the input devices 20 subject to disablement cannot be operated when the children mode is applied. The operation processing module 12 further includes various software components or set of instructions, which may be implemented by the processing unit 40 to re-enable a normal response to all operation commands on any of all the applications of the computer system 100 and to all user operations on any of all the input devices 20 of the computer system 100 when the computer system 100 is switched to the normal mode. The detailed method of determining which of all the applications of the computer system 100 is subject to disablement and which of all the input devices 20 is subject to disablement will be described below.

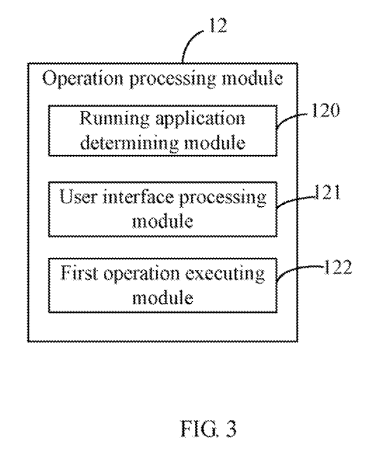

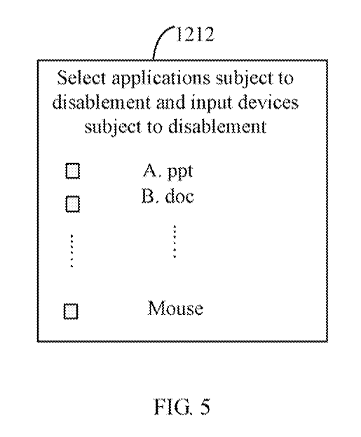

Referring to FIG. 3, in an embodiment, the operation processing module 12 includes a running application determining module 120, a user interface processing module 121, and a first operation executing module 122. The running application determining module 120 is implemented by the processing unit 40 to determine applications or functions which are currently running once the computer system 100 is switched to the children mode. The user interface processing module 121 is implemented by the processing unit 40 to display a user interface 1212 (see FIG. 5) to show the currently running applications and all of the input devices 20 for users to make a selection(s), and record the selected applications as subject to disablement and the selected input devices 20 as subject to disablement. The first operation executing module 122 is implemented by the processing unit 40 to regard any operation command on any of all the applications subject to disablement as an invalid operation command and any user operation on any of all the input devices 20 subject to disablement as an invalid user operation in the children mode. The first operation executing module 122 is further implemented by the processing unit 40 to re-enable a normal response to all operation commands on any of all the applications of the computer system 100 and to all user operations on any of all the input devices 20 of the computer system 100 when the computer system 100 is switched to the normal mode. In this embodiment, the applications subject to disablement cannot be operated when the children mode is applied, thus users need not worry data being lost and/or corrupted.

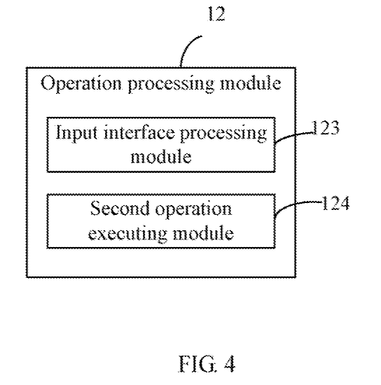

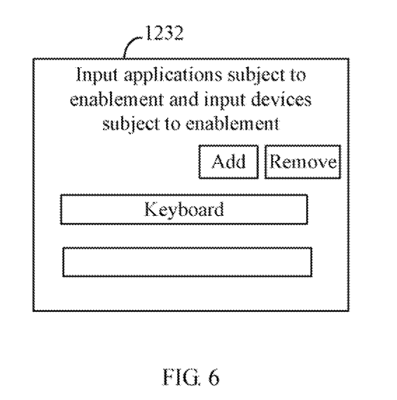

Referring to FIG. 4, in another embodiment, the operation processing module 12 includes an input interface processing module 123 and a second operation executing module 124. The input interface processing module 123 is implemented by the processing unit 40 to display an input interface 1232 (see FIG. 6) for users to input applications subject to enablement and input devices 20 subject to enablement once the computer system 100 is switched to the children mode, and record the applications subject to enablement and the input devices 20 subject to enablement. The applications subject to enablement and the input devices 20 subject to enablement may be considered appropriate for children to operate. The second operation executing module 124 is implemented by the processing unit 40 to determine all applications except for applications subject to enablement as subject to disablement and all the possible input devices 20 except for the input devices 20 subject to enablement as subject to disablement, and regard any operation command on any of the applications subject to disablement as an invalid operation command and any user operation on any of the input devices 20 subject to disablement as an invalid user operation in the children mode. The second operation executing module 124 is further implemented by the processing unit 40 to re-enable a normal response to all operation commands on any of all the applications of the computer system 100 and to all user operations on any of all the input devices 20 of the computer system 100 when the computer system 100 is switched to the normal mode. In this embodiment, currently running applications and any applications not open may not be operated in the children mode.

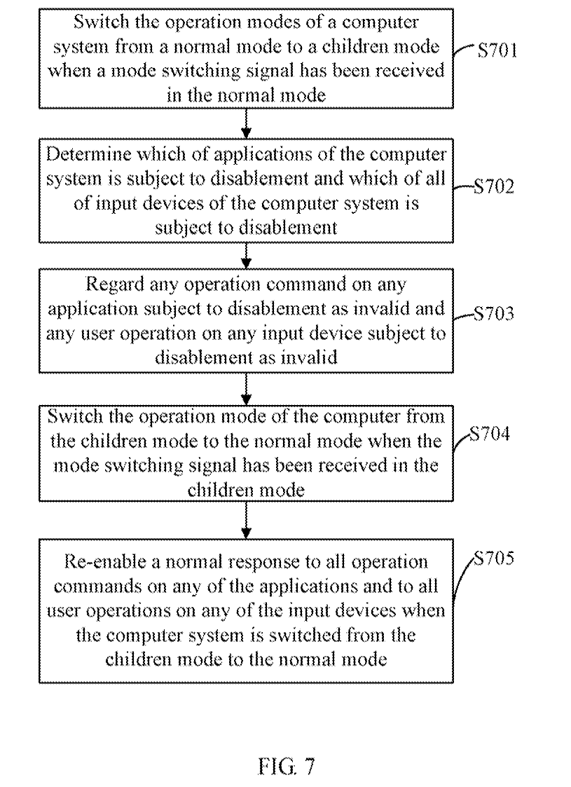

FIG. 7 is a flowchart of a method for controlling the operation of the computer system 100, in accordance with an embodiment.

In step S701, the mode switching module 11 is implemented by the processing unit 40 to change the operation mode of the computer system 100 from the normal mode to the children mode when a mode switching signal has been received from any of the input devices 20 in the normal mode.

In step S702, the operation processing module 12 is implemented by the processing unit 40 to determine which of all the applications of the computer system 100 are subject to disablement and which of all the input devices 20 are subject to disablement once the computer system 100 is switched to the children mode.

In step S703, the operation processing module 12 is implemented by the processing unit 40 to regard any operation command on any of the applications subject to disablement as an invalid operation command, and any user operation on any of the input devices 20 subject to disablement as an invalid user operation if the computer system 100 is in the children mode.

In step S704, the mode switching module 11 is implemented by the processing unit 40 to change the operation mode of the computer system 100 from the children mode to the normal mode when the mode switching signal from one of the input devices 20 has been received in the children mode.

In step S705, the operation processing module 12 is implemented by the processing unit 40 to re-enable a normal response to all operation commands on any of all the applications of the computer system 100 and to all user operations on any of the all the input devices 20 of the computer system 100r.

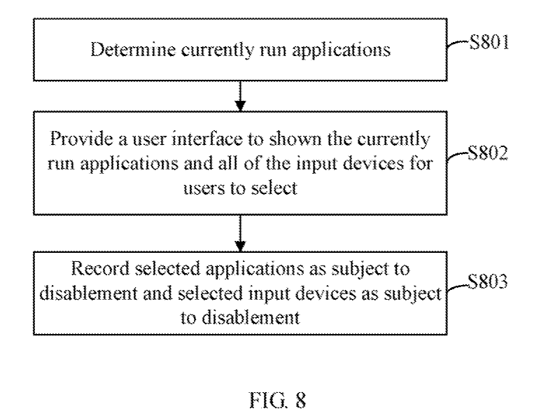

FIG. 8 is a flowchart of a method for determining which of all the applications of the computer system 100 is subject to disablement and which of all the input devices 20 of the computer system 100 is subject to disablement, in accordance with an embodiment.

In step S801, the running application determining module 120 is implemented by the processing unit 40 to determine applications which are currently run once the computer system 100 is switched to the children mode.

In step S802, the user interface processing module 121 is implemented by the processing unit 40 to display a user interface to shown the currently running applications and all of the input devices 20 for users to make a selection(s).

In step S803, the user interface processing module 121 is implemented by the processing unit 40 to record the selected applications as subject to disablement and the selected input devices 20 as subject to disablement.

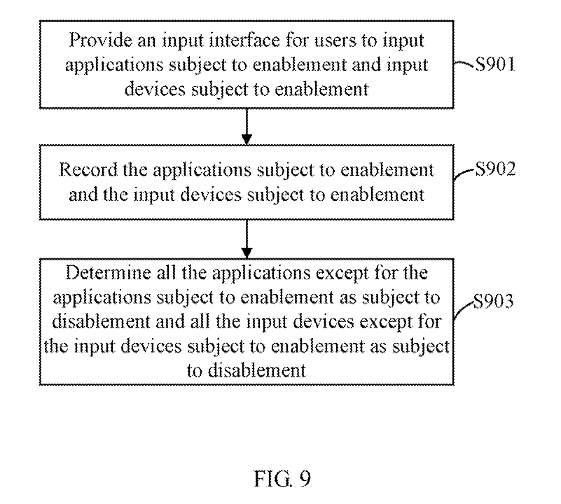

FIG. 9 is a flowchart of a method for determining which of all the applications of the computer system 100 is subject to disablement and which of all the input devices 20 is subject to disablement, in accordance with another embodiment.

In step S901, the input interface processing module 123 is implemented by the processing unit 40 to display an input interface for users to input applications subject to enablement and input devices 20 subject to enablement once the computer system 100 is switched to the children mode.

In step 902, the input interface processing module 123 is implement by the processing unit 40 to record the applications subject to enablement and the input devices 20 subject to enablement.

In step S903, the second operation executing module 124 is implemented by the processing unit 40 to determine all the applications except for the applications subject to enablement as subject to disablement and all the input devices 20 except for the input devices 20 subject to enablement as subject to disablement.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A computer system comprising:
a plurality of input devices;
a storage unit storing a plurality of modules; and
a processing unit to execute the plurality of modules;
wherein the plurality of modules comprises instructions executable by the processing unit to:
switch an operation mode of the computer system from a normal mode to a children mode when a mode switching command has been received from any of the plurality of the input devices;
determine which of applications of the computer system is subject to disablement and which of the plurality of input devices is subject to disablement once the computer system is switched to the children mode; and
regard any operation command on any of the applications subject to disablement as an invalid operation command, and any user operation on any of the input devices subject to disablement as an invalid user operation in the children mode.

2. The computer system as described in claim 1, wherein determining which of applications of the computer system is subject to disablement and which of the plurality of the input devices is subject to disablement once the computer system is switched to the children mode comprises: determining the applications which are currently run once the computer system is switched to the children mode; displaying a user interface showing the currently run applications and the plurality of the input devices for users to select; and recording the selected applications as subject to disablement and the selected input devices as subject to disablement.

3. The computer system as described in claim 1, wherein determining which of applications of the computer system is subject to disablement and which of the plurality of the input devices is subject to disablement once the computer system is switched to the children mode comprises: displaying an input interface for users to input applications subject to enablement and input devices subject to enablement once the computer system is switched to the children mode; recording the applications subject to enablement and the input devices subject to enablement; and determining all the applications except for the applications subject to enablement as subject to disablement and all the input devices except for the input devices subject to enablement as subject to disablement.

4. The computer system as described in claim 1, wherein the plurality of modules further comprises instructions executable by the processing unit to switch the operation mode of the computer system from the children mode to the normal mode when the mode switching command has been received under the children mode.

5. The computer system as described in claim 4, wherein the plurality of modules further comprises instructions executable by the processing unit to re-enable a normal response to all operation commands on any of all the applications of the computer system and to all user operations on any of the plurality of the input devices when the computer system is switched from the children mode to the normal mode.

6. A control method applied in a computer system, comprising:
switching an operation mode of the computer system from a normal mode to a children mode when a mode switching signal has been received in the normal mode;
determining which of applications of the computer system is subject to disablement and which of a plurality of input devices of the computer system is subject to disablement once the computer system is switched to the children mode; and
regarding any operation command on any of the applications subject to disablement as an invalid operation command, and any user operation on any of the input devices subject to disablement as an invalid user operation in the children mode.

7. The control method as described in claim 6, wherein the step of determining which of applications of the computer system is subject to disablement and which of the plurality of the input devices is subject to disablement once the computer system is switched to the children mode comprises:
determining applications which are currently run once the computer system is switched to the children mode;
displaying a user interface showing the currently run applications and the plurality of the input devices for users to select; and
recording the selected applications as subject to disablement and the selected input devices as subject to disablement.

8. The control method as described in claim 6, wherein the step of determining which of applications of the computer system is subject to disablement and which of the plurality of input devices is subject to disablement once the computer system is switched to the children mode comprises:
displaying an input interface for users to input applications subject to enablement and input devices subject to enablement once the computer system is switched to the children mode;
recording the applications subject to enablement and the input devices subject to enablement; and
determining all the applications except for the applications subject to enablement as subject to disablement and all the input devices except for the input devices subject to enablement as subject to disablement.

9. The method as described in claim 6, further comprising:
switching the operation mode of the computer system from the children mode to the normal mode when the mode switching signal has been received under the children mode.

10. The method as described in claim 9, further comprising:
re-enabling a normal response to all operation commands on any of the applications and to all user operations on any of the plurality of the input devices when the computer system is switched from the children mode to the normal mode.
